(19) United States
(12) Patent Application Publication
(10) Pub. No.: US 2026/0359051 A1
(43) Pub. Date: Nov. 12, 2026

(54) Efficient Stack-Related Processor Instructions

(71) Applicant: Google LLC, Mountain View, CA (US)

(72) Inventors: Derek James Basehore, Menlo Park, CA (US); Nicholas Jordan Sanders, Saratoga, CA (US)

(73) Assignee: Google LLC, Mountain View, CA (US)

(21) Appl. No.: 19/488,730

(22) PCT Filed: May 31, 2023
(86) PCT No.: PCT/US2023/067699

§ 371 Date: Nov. 28, 2025

(51) Int. Cl. G06F 9/30; G06F 9/38

(52) U.S. Cl. CPC G06F 9/30134; G06F 9/3851

(57) ABSTRACT

Logic circuitry that supports deferred-writes from physical registers to a stack can implement efficient stack-related processor instructions. For example, the logic circuitry can implement an efficient push instruction that targets a physical register for a data move to the stack by indicating that the data of the physical register corresponds to a pending move. If a corresponding efficient pop instruction is executed while a pending data move indication is valid for the physical register, the logic circuitry can rescind the indication without moving the data to the stack. This can appreciably improve processor performance and power efficiency. However, the data move to the stack may be performed eventually in other cases. The data move may be performed if the physical register associated with the deferred data move is to be used by another instruction and/or if a quantity of unallocated physical registers meets a threshold to protect against processor stalls.

### BACKGROUND

Computing and other electronic devices play integral roles in manufacturing, communication, transportation, healthcare, commerce, social interaction, and entertainment. For example, electronic devices power the server farms that provide cloud-based, distributed computing functionality for commerce, communication, and artificial intelligence (AI). Electronic devices are also embedded in many different types of modern equipment, from medical devices to appliances and from vehicles to industrial tools. Personal electronic devices enable portable video viewing and convenient access to smart digital assistants. Additionally, one versatile electronic device-the smartphone-has practically become a necessity to have within arm's reach. To provide these diverse functionalities, electronic devices typically include multiple different integrated circuits, including one or more processors.

A processor is designed to execute, perform, or otherwise implement multiple different instructions. A group of such instructions can be referred to as an instruction set. The logic circuitry that is capable of implementing the instruction set can be referred to as an instruction set architecture (ISA). Generally, the ISA for a processor is engineered according to multiple tradeoffs, such as power efficiency versus processing performance or selecting between a Reduced Instruction Set Computer (RISC) paradigm or a Complex Instruction Set Computer (CISC) paradigm. In the context of such design choices, computer engineers can determine how many and/or what types of computer instructions are to be supported by a processor. Selecting and creating computer instructions for a processor also entail making one or more tradeoffs, as is described below.

### SUMMARY

This document describes stack-related processor instructions that are efficient in terms of time or power, including both time and power. Stack-related instructions can include an instruction that causes a processor to save a data value to a stack or an instruction that causes a processor to retrieve a data value from the stack. Described implementations can enable some stack-related instructions to be implemented without physically performing a data move to the stack or one “back” from the stack. In an example operation, full performance of a stack-related instruction, such as a physical move of data to the stack, can be deferred until a subsequent time. Further, the physical data move to the stack, as well as a corresponding data move “back” from the stack, can potentially be eliminated, thereby saving both time and power.

To at least reduce some inefficient data moves to and from a stack, this document describes implementations that enable data moves to the stack to be deferred and potentially obviated. Efficient stack-related processor instructions can defer a data move from a physical register of a processor to the stack. Examples of efficient stack-related processor instructions can include an efficient push instruction, an efficient pop instruction, an efficient call instruction, and so forth. With an efficient push instruction, an instruction that targets a physical register for a data move to the stack is implemented, at least initially, by indicating that the physical register is associated with a deferred stack push operation and/or that the data thereof corresponds to a pending move of the data to the stack.

In some cases, the deferred data move to the stack is not performed—e.g., the physical data transfer need never be performed. If a corresponding efficient pop instruction is executed while the deferred or pending data move indication is extant and/or valid for the physical register, the processor can rescind the indication without moving the data to the stack. Further, the processor can continue execution of the program using the data that is still present in the physical register. Thus, two data moves—one from the physical register to the stack and another from the stack back to a physical register—are avoided in these cases. This can appreciably improve processor efficiency.

In other cases, the data move to the stack may be performed eventually. The data move can be performed if the physical register associated with the deferred data move is to be used by another software function—e.g., if the physical register is needed by other code before the corresponding efficient pop instruction is executed. The data movement from the physical register to the stack can also be performed if a quantity of unallocated physical registers meets at least one threshold. For instance, the processor can perform the data move responsive to a quantity of available physical registers dropping below a level that is unlikely to avoid stalling the execution of code by the processor. This approach also enables stack saves of multiple registers to be grouped together, which can increase the efficiency of writes to a memory storing the stack, such as a first-level cache of the processor.

In these manners, efficient stack-related processor instructions can save power and time as compared to stack-related instructions that do not defer data moves to the stack. These techniques can be implemented by incorporating logic circuitry that manages deferred stack moves to avoid losing data. The logic circuitry can further reduce processor stalls by occasionally performing one or more data moves to the stack based on a quantity of unallocated physical registers that are currently available. The following and other example implementations are described herein.

In example implementations, an apparatus for realizing efficient stack-related processor instructions includes multiple physical registers, at least one memory, and logic circuitry coupled to the multiple physical registers and the at least one memory. The logic circuitry is configured to identify a physical register that is targeted by an instruction to move data stored in the physical register to a stack that is stored in the at least one memory. The logic circuitry is also configured to establish an indication that the physical register is associated with a pending move of the data to the stack responsive to the instruction.

In example implementations, a method for realizing efficient stack-related processor instructions includes identifying a physical register that is targeted by an instruction to move data stored in the physical register to a stack that is stored in at least one memory. The method also includes establishing an indication that the physical register is associated with a pending move of the data to the stack responsive to the instruction.

In other example implementations, an apparatus includes a processor configured to perform a method for realizing efficient stack-related processor instructions.

In example implementations, a processor for implementing efficient stack-related processor instructions includes multiple physical registers and logic circuitry coupled to the multiple physical registers. The logic circuitry is configured to defer a data move from a physical register of the multiple physical registers to a stack in response to an instruction to perform the data move and based at least partially on a quantity of unallocated physical registers of the multiple physical registers.

### BRIEF DESCRIPTION OF DRAWINGS

Apparatuses of and techniques for efficient stack-related processor instructions are described with reference to the following drawings. The same numbers are used throughout the drawings to reference like features and components.

FIG. 1 illustrates an example apparatus with at least one integrated circuit (IC) that includes a processor or other circuitry that can implement efficient stack-related processor instructions.

FIG. 2 illustrates an example first architecture in which efficient stack-related processor instructions can be implemented.

FIG. 2-1 illustrates example implementations for processing an efficient instruction that pertains to moving data from a physical register to a stack in the first architecture.

FIG. 2-2 illustrates example implementations for processing an efficient instruction that pertains to moving data back from the stack to the physical register in the first architecture.

FIG. 2-3 illustrates example implementations for processing an instruction that results in a physical register being freed for use in the first architecture.

FIG. 3 illustrates an example second architecture in which efficient stack-related processor instructions can be implemented.

FIG. 3-1 illustrates example implementations for processing an efficient instruction that pertains to moving data from a physical register to a stack in the second architecture.

FIG. 3-2 illustrates example implementations for processing an efficient instruction that pertains to moving data back from the stack to the physical register in the second architecture.

FIG. 3-3 illustrates example implementations for processing an instruction that results in a physical register being freed for use in the second architecture.

FIG. 4 is a flow chart illustrating an example process for implementing efficient stack-related processor instructions.

FIG. 5 is a flow diagram illustrating an example process for implementing efficient stack-related processor instructions.

FIG. 6 illustrates various components of an example electronic device that can implement efficient stack-related processor instructions in accordance with one or more described aspects.

### DETAILED DESCRIPTION

### Overview

Electronic devices make important contributions to modern society, such as those related to communication, safety, manufacturing, and content creation. Each electronic device relies on multiple integrated circuits (ICs), some of which possess processing capabilities. These processor ICs are engineered to execute a set of instructions. Computer engineers select or create instructions that are to be included in an instruction set by balancing cost and complexity versus processing performance and power efficiency. Instructions that can increase processing performance and power efficiency without unduly increasing cost and complexity can add value to an instruction set architecture (ISA) of a processor.

This document describes stack-related processor instructions that are efficient in terms of time, which can provide increased processing performance, and/or energy usage, which can provide increased power efficiency. Stack-related instructions can include an instruction that causes a processor to save a value to a stack or an instruction that causes a processor to retrieve a value from the stack. Described implementations can enable some stack-related instructions to be implemented without physically performing a data move to the stack or a data move away from the stack. In an example operation, full performance of a stack-related instruction, such as a data move to the stack, can be deferred until a later time. Further, the physical data move to the stack, as well as a corresponding data move “back” from the stack, can potentially be eliminated, thereby saving both time and power.

Generally, processors include multiple registers to perform operations, such as mathematical and logical operations. The registers serve as a temporary holding spot, or “scratchpad,” for values that are being manipulated by an arithmetic logic unit (ALU) or other logic circuitry that is engineered to implement processor instructions. For example, an operation of a first software function may add first and second values that are respectively located in first and second registers and place the sum in a third register. A processor is usually executing, however, multiple software functions either in an overlapping manner or in a nesting manner as one function calls another. As result, a second software function may request use of the three registers before the first software function is finished with the registers. In other words, multiple software functions may be sharing a finite number of registers such that the first software function is to relinquish “ownership” of the three registers while still having additional code to execute that will use one or more of the data values that are stored in the three registers.

To accommodate this sharing between two or more software functions of the multiple registers of the processor, the processor can save the data values stored in the first through the third registers into another memory area, which may be referred to as a stack. This data movement operation may be referred to as pushing values onto the stack, which can be responsive to a push instruction. When the processor can return to executing the first software function in the future, the processor retrieves the three values from the stack and restores them to the first through the third registers. This data restoration operation may be referred to as popping the values off the stack, which can be responsive to a pop instruction. In this manner, complex computer programs with multiple software functions that are “simultaneously” executing can use a limited number of registers.

To further accelerate program execution, processors can engage in out-of-order execution. For example, three operations that are independent of each other may be performed in any convenient order, including in a manner that is at least partially overlapping. Further, a processor can perform speculative execution, which involves implementing operations that produce results that may or may not be used, depending on the results of other code portions. To support out-or-order execution, some processors include more physical registers than logical registers. A logical register may refer, for instance, to a name of a register as used by a programmer in a computer program. A quantity and/or the names of logical registers may be specified by an architecture of a processor. By way of example only, a processor may include two to eight times more physical registers than logical registers.

During code execution, a processor maps a logical register to a physical register and maintains a record of the mapping while the mapping persists. The mapping may be maintained, for instance, in a register mapping table. An entry of the register mapping table can map a logical register name to a physical register, using an offset to the physical register for instance. By including a greater quantity of physical registers than a quantity of logical registers that are enabled, a processor can support out-of-order execution and facilitate the overlapping or simultaneous execution of multiple software functions.

Push and pop instructions relate to stack operations. In some approaches, responsive to a push instruction targeting a physical register as identified by a mapped logical register, the processor moves data from the physical register to the stack. At some point, a corresponding pop instruction targeting the logical register moves data from the stack back to some physical register, which may be the same previous physical register. Due to the ratio of physical-to-logical registers being greater than one, however, these two data moves may be unnecessary, and thus inefficient as described herein. In some cases, the physical register is not used by another operation between the push instruction and the corresponding pop instruction. Accordingly, in such cases, the data could have been left in the physical register.

If the data were left in the physical register instead of being transferred to and from the stack, the two data moves could be eliminated. At times, the stack, or at least part of the stack, can be located in a first-level cache of the processor. Thus, the processor moves the data from one or more physical registers to the cache at one time and then at a subsequent time moves the data from the cache back to the one or more physical registers. These data moves consume power and time, even if the stack is stored in the first-level cache of the processor. Further, at least the relevant portion of the stack may be stored in a lower-level cache or even in main memory. If so, one or both of the two data movements can involve significantly more time and energy to complete.

To reduce or at least partially ameliorate some of these inefficient data moves, this document describes other approaches that enable data moves to a stack to be deferred and potentially obviated. Efficient stack-related processor instructions can defer a data move from a physical register to the stack. Examples of efficient stack-related processor instructions can include an efficient push instruction, an efficient pop instruction, an efficient call instruction, and so forth. Regarding an efficient push instruction, an instruction that targets a physical register for a data move to the stack is implemented, at least initially, by indicating that the physical register is associated with a deferred stack push operation and/or that the data thereof corresponds to a pending move to the stack.

In some cases, the deferred data move to the stack is not performed—e.g., the data movement need never be performed. If a corresponding efficient pop instruction is received while the deferred or pending data move indication is extant and/or valid for the physical register and/or the data thereof, logic circuitry of the processor can rescind the indication without writing the data to the stack. Further, the processor can continue program execution using the data that is still present in the physical register. Thus, two data moves—one from the physical register to the stack and another from the stack back to some physical register—are avoided in these cases. This can appreciably improve processor efficiency.

In other cases, the data move to the stack may be performed subsequently. The data move can be performed if the physical register associated with the deferred data move is to be used by another software function—e.g., if the physical register is needed by other code before the corresponding efficient pop instruction is executed. The data move from the physical register to the stack can also be performed if a quantity of unallocated physical registers meets at least one threshold. For instance, the logic circuitry of the processor can perform the data move responsive to a quantity of available physical registers dropping below a level that is unlikely to avoid stalling code execution by the processor. These approaches also enable stack saves of multiple registers to be batched together, which can increase the efficiency of writing data to a memory storing the stack, such as a first-level cache of the processor.

The expectations of processor operation that are held by programmers and the programs they produce may be contravened by deferring data moves to the stack. Providing notice of how these efficient stack-related processor instructions operate, however, enables such programmers and programs to benefit from their advantages. For example, efficient stack-related processor instructions can save power and time as compared to stack-related instructions that do not defer data moves to the stack. These techniques can be implemented by incorporating logic circuitry that manages deferred stack moves to avoid losing data, such as by tracking mappings between logical registers and physical registers. The logic circuitry can further reduce processor stalls by occasionally performing one or more data moves to the stack based on a quantity of unallocated physical registers that are currently available. These and other implementations are described herein.

### Example Environments and Electronic Devices

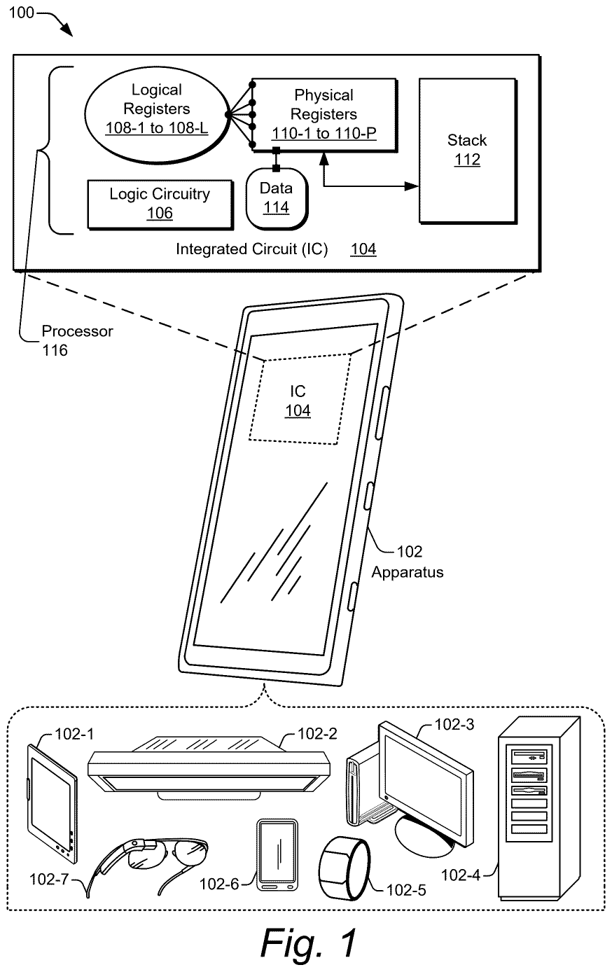

FIG. 1 illustrates, at 100 generally, an example apparatus 102 with at least one integrated circuit 104 (IC 104) that includes a processor 116 and/or other circuitry (e.g., logic circuitry 106) that can implement efficient stack-related processor instructions. The apparatus 102, the integrated circuit 104, the processor 116, and/or the logic circuitry 106 can implement efficient stack-related processor instructions as described herein. Efficient stack-related processor instructions can be implemented in conjunction with at least one stack 112 and multiple physical registers 110-1 . . . 110-P, with “P” representing an integer greater than one. In this example, the apparatus 102 is depicted as a smartphone. The apparatus 102 may, however, be implemented as any suitable computing or other electronic device.

Examples of the apparatus 102 include a mobile electronic device or mobile device, mobile communication device, modem, cellular or mobile phone, mobile station, gaming device, navigation device, media or entertainment device (e.g., a media streamer or gaming controller), laptop computer, desktop computer, tablet computer, smart appliance, vehicle-based electronic system, wearable computing device (e.g., clothing, watch, or reality-altering glasses), Internet of Things (IoTs) device, sensor, stock management device, electronic portion of a machine or piece of equipment (e.g., vehicle or robot), memory storage device (e.g., a solid-state drive (SSD)), server computer or portion thereof (e.g., a server blade or rack or another part of a datacenter), and the like. Illustrated examples of the apparatus 102 include a tablet device 102-1, a smart television 102-2, a desktop computer 102-3, a server computer 102-4, a smartwatch 102-5, a smartphone (or document reader) 102-6, and intelligent glasses 102-7.

In example implementations, the apparatus 102 includes at least one integrated circuit 104. The integrated circuit 104 can be part of or realized as a chip, a package, a module, an assembly, or at least one printed circuit board (PCB) (not shown). Examples of a PCB include a flexible PCB, a rigid PCB, a single or multi-layered PCB, a surface-mounted or through-hole PCB, combinations thereof, and so forth. One or more integrated circuit (IC) chips can be mounted on a PCB. Each IC chip can be realized as a general-purpose processor, a microcontroller, an application-specific IC (ASIC), and so forth. Other examples of IC chips include a system-on-a-chip (SoC), a security-oriented IC chip, a memory chip, a communications IC chip (e.g., a modem or radio-frequency IC), a graphics processor, an artificial intelligence (AI) accelerator, sensor chips, combinations thereof, and so forth. Sensor chips may include, for example, an accelerometer, a camera or other light sensor, a satellite positioning system (e.g., a Global Positioning System (GPS)) chip, and the like. An integrated circuit chip can be packaged alone or together with other IC chips.

As shown, the integrated circuit 104 includes the logic circuitry 106, the multiple physical registers 110-1 to 110-P, and the stack 112 as described above. The integrated circuit 104 is also illustrated to include multiple logical registers 108-1 . . . 108-L, with “L” representing a positive integer. In some situations, a logical register 108 may be referred to by programmers simply as a “register.” One or more instances of data 114 can be stored in a logical register 108 e.g., as realized on an integrated circuit 104 by a physical register 110. The logic circuitry 106, the multiple physical registers 110-1 to 110-P, and/or the stack 112 may be part of a processor 116 or may be fully or partially separate therefrom.

Although not explicitly shown in FIG. 1, the components used to implement efficient stack-related processor instructions may include other aspects, including other parts. Although a single integrated circuit 104 is depicted in FIG. 1, such components can be distributed across multiple ICs. In other words, although the components for implementing efficient stack-related processor instructions may be disposed together on a single IC 104 as shown, such components may alternatively be distributed across two or more ICs. For example, at least part of at least one memory that stores the stack 112 may be on a separate IC than that of the logic circuitry 106 and/or of the multiple physical registers 110-1 to 110-P.

In example implementations, moves of the data 114 from a physical register 110 to the stack 112 can be deferred and potentially obviated by efficient stack-related processor instructions. Examples of efficient stack-related processor instructions can include an efficient push instruction, an efficient pop instruction, an efficient call instruction, an efficient return instruction, and so forth. With an efficient push instruction, an instruction that targets a physical register 110 for a data move to the stack 112 is implemented, at least initially, by indicating that the physical register 110 is associated with a deferred stack push operation and/or that the data 114 thereof corresponds to a pending move of the data 114 to the stack 112. Examples of this are described below with reference to FIGS. 2-1 and 3-1.

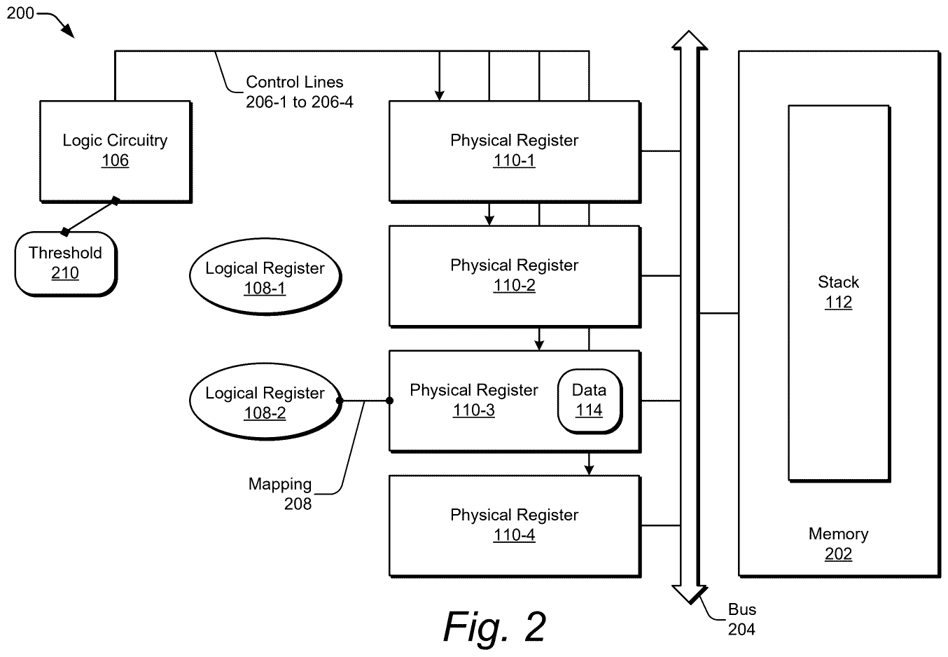

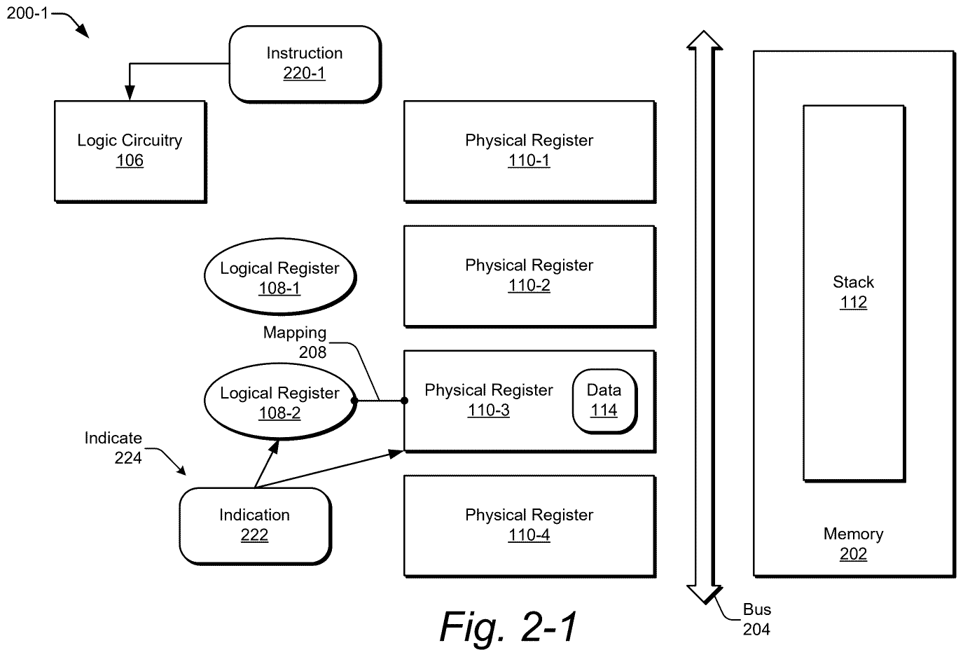

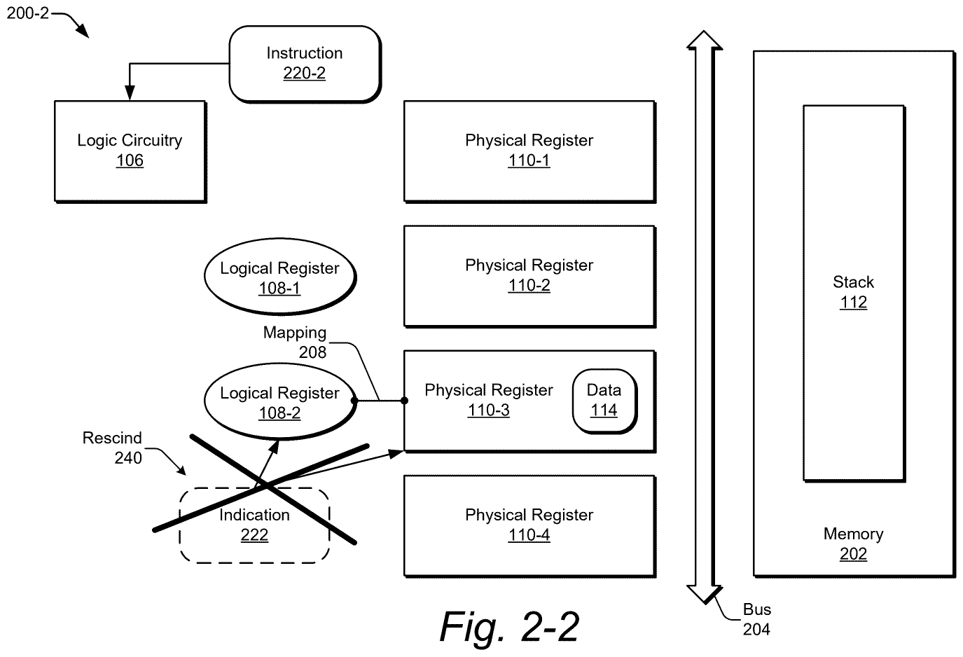

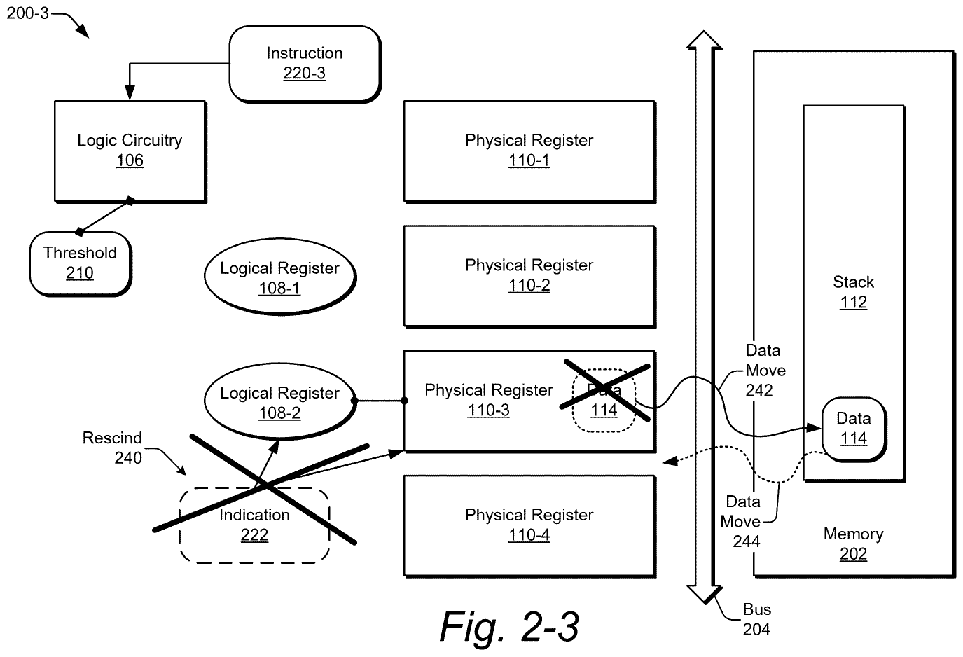

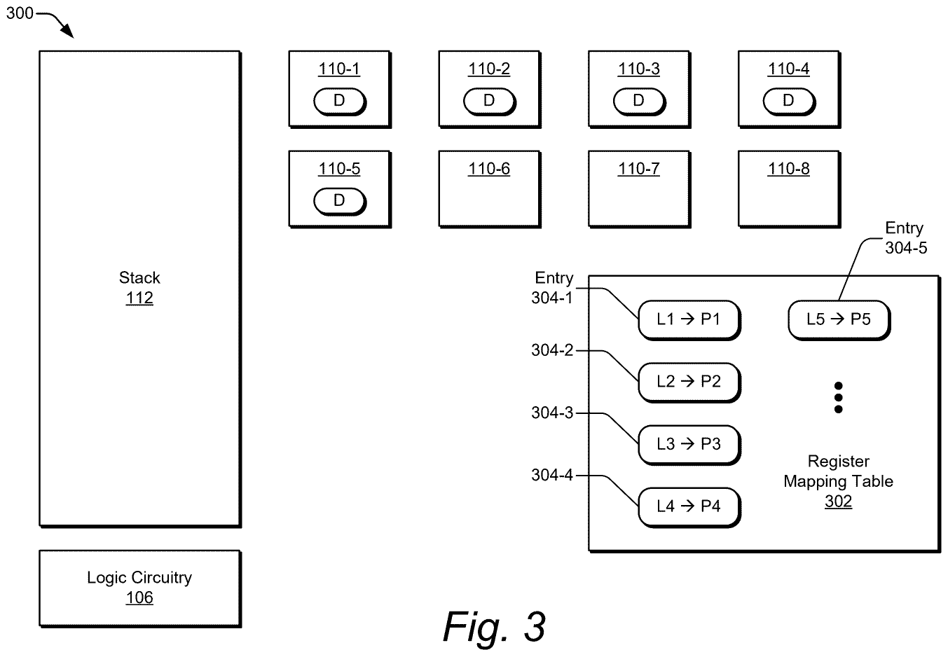

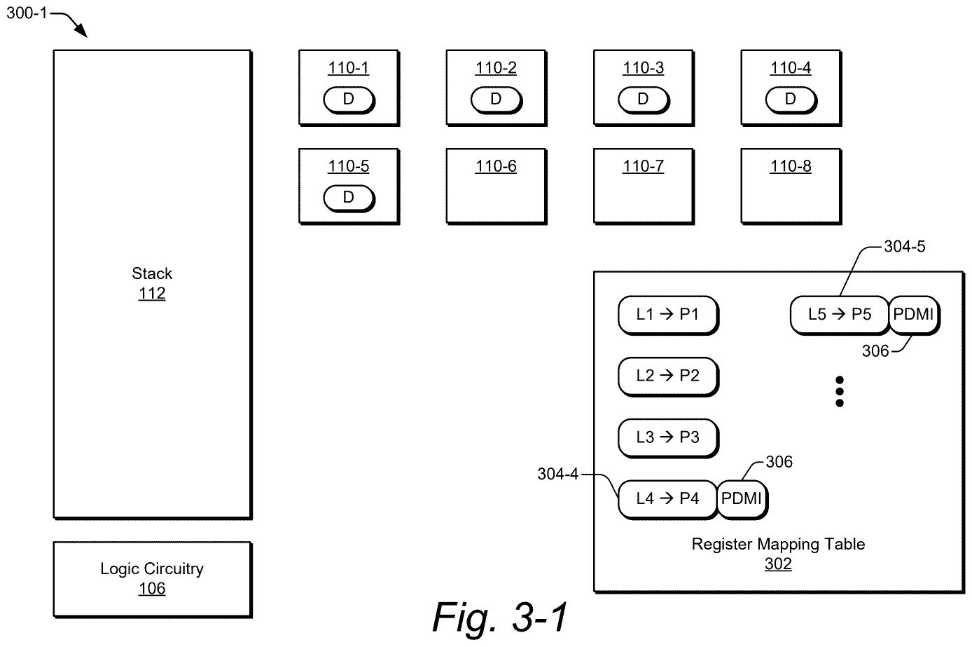

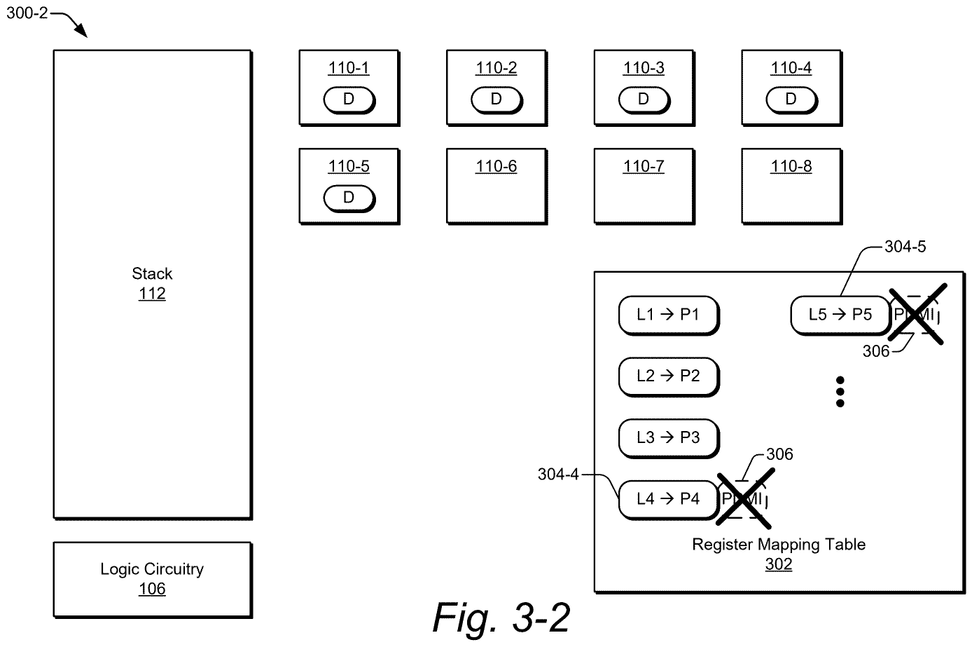

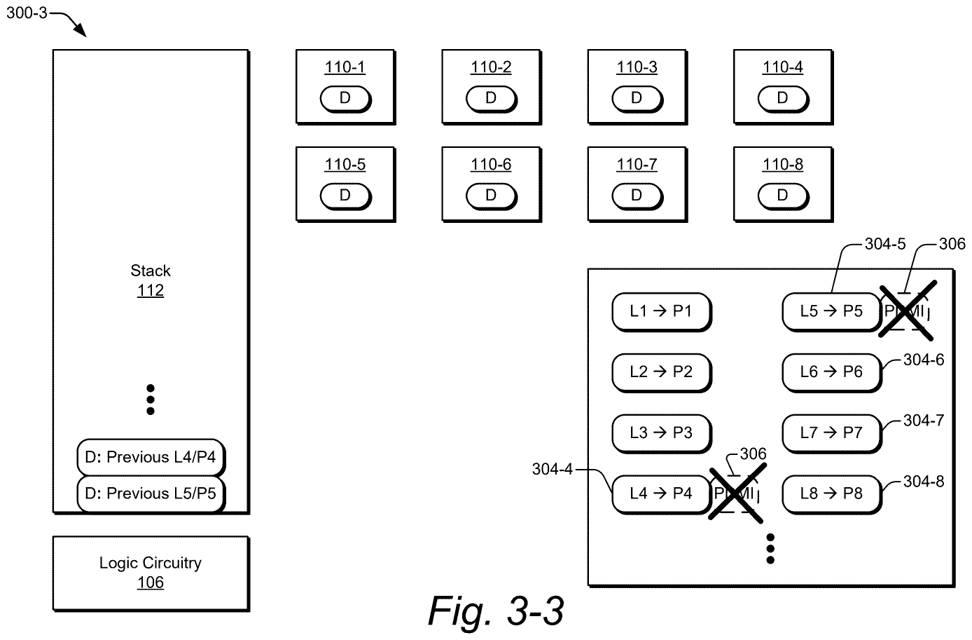

In some cases, the deferred data move to the stack 112 is not performed—e.g., the physical data transfer need never be performed. If a corresponding efficient pop instruction is executed while the deferred or pending data move indication is valid for the physical register 110, the processor 116 can rescind the indication without moving the data 114 to the stack 112. Examples of this are described below with reference to FIGS. 2-2 and 3-2. Further, the processor 116 can continue execution of a program using the data 114 that is still present in the physical register 110.

In other cases, the data move to the stack 112 may be performed eventually. Examples of this are described below with reference to FIGS. 2-3 and 3-3. The data move can be performed if the physical register 110 associated with the deferred data move is to be used by another software function—e.g., if the physical register 110 is needed by other code before the corresponding efficient pop instruction is executed. The data movement from the physical register to the stack can also be performed if a quantity of unallocated physical registers meets at least one threshold—e.g., to maintain at least one available physical register to reduce processor stalls. In these manners, efficient stack-related processor instructions can save power and time as compared to stack-related instructions that do not defer data moves to the stack. These and other aspects are described herein, including with reference to FIG. 2, which depicts an example architecture that is leveraged for FIGS. 2-1 to 2-3. Analogously, FIG. 3 depicts an example architecture that is leveraged for FIGS. 3-1 to 3-3.

In some stack machine execution models, which are applicable to many general-purpose computing models, data values in registers are saved and restored using a caller/callee convention. A general-purpose register space may be split into two sets: caller saved registers and callee saved registers. Two instructions, for instance, can be used to manipulate data storage between the registers and a stack: push instructions and pop instructions. Non-efficient push and pop instructions are respectively used to write data values to a stack in memory with deferral and to read data values from the stack. Thus, data values in registers can be preserved by pushing the data values to the stack and then later popping the data values “off” the stack when they are to be used again by a software function.

With some implementations of central processing units (CPUs), particularly more performance-oriented ones, their architecture includes more physical registers than there are general-purpose register names, or logical registers. The assignment of logical registers to physical registers during runtime can be referred to as register renaming. During execution, registers can be renamed for CPU instructions and may be renamed for the purposes of out-of-order execution.

Register renaming can entail assigning logical registers to physical registers. With this renaming, logical registers (e.g., the multiple logical registers 108-1 to 108-8, with “L” equal to eight in this example) can be dynamically mapped to physical registers (e.g., the multiple physical registers 110-1 to 110-32, with “P” being equal to an example 32). This allows out-of-order execution to avoid certain bottlenecks that might otherwise occur during code execution. Register renaming can also enable convenient optimizations for certain CPU instructions, such as the swap instruction that swaps the values of two registers. To perform a swap instruction, the CPU can swap the logical register assignments instead of physically moving data values between two physical registers.

With register renaming and the existence of more physical registers than logical registers, there can be separate instances of the same general-purpose register being present at the same time. When registers are pushed to the stack as a save mechanism because the program expects to overwrite the current values, the values in the physical registers may not actually be overwritten before the values are popped “back” off the stack due to the surplusage of physical registers. Certain techniques that are described herein for efficient stack-related processor instructions can leverage these operational characteristics and the presence of “extra” physical registers.

### Example Apparatuses and Operational Schemes

FIG. 2 illustrates an example first architecture 200 in which efficient stack-related processor instructions can be implemented. As shown, the first architecture 200 can include the logic circuitry 106; at least two logical registers 108-1 and 108-2; at least four physical registers 110-1, 110-2, 110-3, and 110-4; at least one memory 202; and at least one bus 204. Although two logical registers and four physical registers are depicted for this example architecture and referenced in the description below, other architectures may have more (or fewer) local registers and/or physical registers. As shown, the multiple physical registers 110-1 to 110-4 and the memory 202 are coupled to the bus 204. The memory 202 can store the stack 112, and at least one physical register 110 of the multiple physical registers 110-1 to 110-4 can store data 114, such as an instance of data 114 or a data value 114. Although not shown in FIG. 2, the stack 112 may also store data 114 as described herein. The example first architecture 200 can also include multiple control lines 206-1 . . . 206-4, which may have a quantity different from that of the multiple physical registers 110-1 to 110-4.

In some implementations, data 114 can be moved (e.g., propagated or transferred) over the bus 204 between the multiple physical registers 110-1 to 110-4 and the memory 202 unidirectionally or bidirectionally. The at least one bus 204 may include multiple buses. The buses may be internal to an integrated circuit, external of an integrated circuit, or a combination thereof. For example, the memory 202 may comprise on-chip cache memory that is formed from static random-access memory (SRAM), such as a first-level cache or a second-level cache of a processor. Additionally or alternatively, the memory 202 may include main memory, such as dynamic random-access memory (DRAM) that is part of a separate IC chip. The stack 112 may be stored in a single physical or type of memory, such as an on-chip cache. Alternatively, the stack 112 may be distributed across multiple memory types, such as partially in a first-level cache, partially in a second-level cache, and partially in main memory. At least a portion of the stack 112 may be moved into storage memory (e.g., flash memory) as part of a virtual memory paging operation.

In example implementations, the logic circuitry 106 is coupled to the multiple physical registers 110-1 to 110-4 and/or the at least one memory 202, including via a cache interface or a memory controller in some cases. The logic circuitry 106 can execute instructions in terms of the multiple logical registers 108-1 and 108-2. A logical register 108 may be mapped to a physical register 110. For instance, a mapping 208 can represent an assignment of the logical register 108-2 to the physical register 110-3, an allocation of the physical register 110-3 to the logical register 108-2, an entry in a register mapping table (not shown in FIG. 2) that maps or links the logical register 108-2 to the physical register 110-3, some combination thereof, and so forth.

The example architecture 200 can also include multiple control lines 206-1 to 206-4 that couple the logic circuitry 106 respectively to the multiple physical registers 110-1 to 110-4. The logic circuitry 106 can use the multiple control lines 206-1 to 206-4 to control operation of the multiple physical registers 110-1 to 110-4. The logic circuitry 106 can cause each physical register 110 to load, output, transfer, move, etc. an instance of data 114. In alternative implementations, the logic circuitry 106 can be coupled to the multiple physical registers 110-1 to 110-4 in different manners, including at least partially using shared control lines or a control bus.

The logic circuitry 106 can control multiple operations of other circuitry—e.g., for a processor 116 (of FIG. 1) or a microcontroller. The logic circuitry 106 can execute instructions, perform register renaming, control data movement to and from the stack 112 relative to the multiple physical registers 110-1 to 110-4, and so forth. Although not shown, the logic circuitry 106 can include, or at least be coupled to, units to perform mathematical and/or logical operations, such as an arithmetic logic unit (ALU). The logic circuitry 106 can also include or otherwise have access to a threshold 210 that impacts when or if data 114 is transferred to the stack 112 from a physical register 110 that is associated with a pending stack transfer of the data 114. Example applications of the threshold 210 are described below with reference to FIG. 2-3.

As shown, the third physical register 110-3 is storing data 114, and the third physical register 110-3 is allocated to the second logical register 108-2 as per the mapping 208. This example scenario is used to describe example techniques for efficient stack-related processor instructions with reference to FIGS. 2-1 to 2-3.

FIG. 2-1 illustrates example implementations 200-1 for processing an efficient instruction 220-1 that pertains to moving data 114 from the physical register 110-3 to the stack 112 in the first architecture 200 (of FIG. 2). In example operations, the logic circuitry 106 can identify the physical register 110-3 that is targeted by the instruction 220-1 to move data 114 stored in the physical register 110-3 to a stack 112 that is stored in the at least one memory 202. The instruction 220-1 may comprise an efficient stack-related processor instruction pertaining to at least one data move from the multiple physical registers 110-1 to 110-4 to the stack 112. The instruction 220-1 may reference the logical register 108-2 that is mapped 208 to the physical register 110-3.

The at least one data move may be deferrable based on a quantity of available physical registers of the multiple physical registers 110-1 to 110-4 (e.g., based also on the threshold 210 as described below with reference to FIG. 2-3). Examples of efficient instructions in this context may include an efficient push instruction and an efficient call instruction. The logic circuitry 106 can also indicate 224, or establish an indication 222, that the physical register 110-3 is associated with a pending move of the data 114 to the stack 112 responsive to the instruction 220-1.

The indication 222 can be realized in any of many different forms. Example forms include at least one bit that corresponds to the physical register 110-3, one or more bits that are included in an entry of a register mapping table that maps the physical register 110-3 to the logical register 108-2, a separate entry in the same or a different register mapping table that links the “current” logical register 108-2 to the physical register 110-3 in conjunction with an indication that the physical register 110-3 corresponds to a deferred write to the stack 112, some combination thereof, and so forth. The indication 222, relative to a register mapping table, may include distinct bit(s) indicative of a deferred stack move in a “general” register mapping table or may include the existence of an entry in a table or table portion that is designated for deferred data stack moves. The indication 222 may correspond to, for example, the second logical register 108-2, the third physical register 110-3, the second logical register 108-2 and the third physical register 110-3, and so forth.

The indication 222 may also be implemented in other manners. For example, the logic circuitry 106 can write to at least one bit corresponding to the physical register 110-3 to establish the indication 222 that the physical register 110-3 is associated with a pending move of the data 114 to the stack 112. Additionally or alternatively, the logic circuitry 106 can write to at least one table corresponding to the multiple physical registers 110-1 to 110-4 to establish the indication 222 that the physical register 110-3 is associated with a pending move of the data 114 to the stack 112. The at least one bit may be part of or separate from the table. The table may be realized as a register mapping table, examples of which are described below with reference to FIGS. 3 to 3-3.

After the logic circuitry 106 indicates 224 that the physical register 110-3 is associated with the pending data move, time elapses, and other code is executed. In some cases, another instruction 220 can be received that targets the second logical register 108-2 and thus the data 114 that is still stored in the third physical register 110-3. Examples of this scenario are described next with reference to FIG. 2-2.

FIG. 2-2 illustrates example implementations 200-2 for processing an efficient instruction 220-2 that pertains to moving data 114 “back” from the stack 112 to the physical register 110-3 in the first architecture 200 (FIG. 2). In example operations, the logic circuitry 106 can rescind 240 the indication 222 that the physical register 110-3 is associated with a pending move of the data 114 to the stack 112 responsive to another instruction 220-2 that targets the data 114 of the physical register 110-3 for a move from the stack 112. Examples of efficient instructions in this context may include an efficient pop instruction and an efficient return instruction.

In some aspects, the logic circuitry 106 can allocate the physical register 110-3 to the logical register 108-2 based on the indication 222 and responsive to another instruction 220-2 that targets the data 114 of the physical register 110-3 for a move from the stack 112 to the multiple physical registers 110-1 to 110-4. Because the data 114 is still stored by the register 110-3, the logic circuitry 106 can “select” the physical register 110-3 for the mapping 208. Thus, the logic circuitry 106 may reallocate the physical register 110-3 to the logical register 108-2 while the data 114 is continuously stored in the physical register 110-3 between processing the instruction 220-1 (of FIG. 2-1) and processing the other instruction 220-2.

In some cases, the logic circuitry 106 may reactivate in a register mapping table an entry that maps the logical register 108-2 to the physical register 110-3 to reallocate the physical register 110-3 to the logical register 108-2 responsive to the other instruction 220-2. In other cases, the logic circuitry 106 may move a mapping entry to a different register mapping table or a different part of the same register mapping table, may create a new mapping entry, some combination thereof, and so forth to reallocate the physical register 110-3 to the logical register 108-2. Examples of register mapping tables, and entries thereof, are described below with reference to FIGS. 3 to 3-3.

FIG. 2-3 illustrates example implementations 200-3 for processing an instruction 220-3 that results in a physical register 110, such as the physical register 110-3, being freed for use in the first architecture 200 (FIG. 2). The instruction 220-3 may be an instruction that results in the physical register 110-3 in particular being allocated to a logical register 108 that is to be used by the instruction 220-3 or may be another instruction that is related thereto. Alternatively, the instruction 220-3 may be an instruction that causes one or more other physical registers to become allocated, which results in too few unallocated physical registers being available relative to the threshold 210. This can precipitate the logic circuitry 106 making the physical register 110-3 available, as is described below.

Regardless, the third physical register 110-3 is to be freed for use as part of managing the data movement between the multiple physical registers 110-1 to 110-4 and the stack 112. To do so, the logic circuitry 106 can move the data 114, or perform a data move 242, from the physical register 110-3 to the stack 112 responsive to the indication 222 and to another instruction 220-3 that is to use at least one physical register 110 of the multiple physical registers 110-1 to 110-4. In some cases, the at least one physical register 110 can comprise the physical register 110-3 that is storing the data 114 prior to processing the other instruction 220-3. Based on the data move 242, the logic circuitry 106 can rescind 240 the indication 222, such as by changing at least one bit that represents the indication 222, by writing to a different bit indicative of clearing the indication 222, by removing or overwriting an entry in a register mapping table, some combination thereof, and so forth.

In some aspects, the logic circuitry 106 can maintain a certain level of availability amongst the multiple physical registers 110-1 to 110-4 to reduce a likelihood that the processor 116 stalls because a data move 242 needs to occur before another instruction can be executed due to a deferred stack write. For example, the logic circuitry 106 can move the data 114 from the physical register 110-3 to the stack 112 based on a quantity of unallocated physical registers of the multiple physical registers 110-1 to 110-P and at least one threshold 210. For instance, if a processor 116 includes 32 physical registers (e.g., “P=32”), the logic circuitry 106 can preemptively move the data 114 to the stack 112 to ensure that six physical registers remain available, with the threshold 210 equaling six in this instance. Analogously, the threshold 210 can be 26, and the comparison can involve comparing the threshold 210 to a quantity of allocated physical registers. In this context, a physical register 110 that corresponds to a deferred data move to the stack 112 as represented by an associated indication 222 is unavailable (e.g., is not unallocated) until the data move 242 is performed and the physical register 110 can accept other data. Further, basing a data move decision on a quantity of allocated physical registers can be basing the data move decision on a quantity of unallocated physical registers, and vice versa.

In some cases, the data move 242 of FIG. 2-3 is performed after an efficient push instruction produces the scenario depicted in FIG. 2-1. In these cases, in response to a corresponding efficient pop instruction, the logic circuitry 106 cannot merely rescind 240 the indication 222 as shown in FIG. 2-2 because the data 114 is no longer being stored in the physical register 110-3. Thus, as illustrated in FIG. 2-3, the logic circuitry 106 can perform another data move 244 “back” to a physical register 110 of the multiple physical registers 110-1 to 110-4 to perform the corresponding efficient pop instruction.

FIG. 3 illustrates an example second architecture 300 in which efficient stack-related processor instructions can be implemented. As shown, the example second architecture 300 can include the logic circuitry 106; at least eight physical registers 110-1, 110-2, 110-3, 110-4, 110-5, 110-6, 110-7, and 110-8; and at least one register mapping table 302. Although not explicitly shown in FIG. 3, the logic circuitry 106 can operate using multiple logical registers, which is reflected in FIG. 3 by the mapping entries that include an “L #” designation in the register mapping table 302. Further, the logic circuitry 106 can manage a quantity of unallocated physical registers based on at least one threshold, such as the threshold 210 (of FIGS. 2 and 2-3). Although eight physical registers are depicted for this example architecture, other architectures may have more (or fewer) physical registers.

Additionally, although one register mapping table 302 is illustrated, described techniques can employ multiple register mapping tables, distributed portions of a given register mapping table, a combination thereof, and so forth. The principles that are described with reference to the example first architecture 200 in FIGS. 2 to 2-3 may be used in the example second architecture 300 of FIGS. 3 to 3-3, and vice versa. For example, implementations for an indication 220 can be deployed in the second architecture 300. Similarly, implementations for a register mapping table 302 can be deployed in the first architecture 200, such as in conjunction with a mapping 208 and/or an indication 222.

In example implementations, and for scenarios as depicted in FIG. 3, five physical registers 110-1 to 110-5 may be storing data, as represented by “D.” The register mapping table 302 includes multiple entries, or mapping entries, such as the entries 304-1, 304-2, 304-3, 304-4, and 304-5. In the illustrated mapping example, the mapping entry 304-1 maps a first logical register L1 to a first physical register P1. The mapping entry 304-2 maps a second logical register L2 to a second physical register P2, and the mapping entry 304-3 maps a third logical register L3 to a third physical register P3. The mapping entry 304-4 maps a fourth logical register L4 to a fourth physical register P4, and the mapping entry 304-5 maps a fifth logical register L5 to a fifth physical register P5.

FIG. 3-1 illustrates example implementations 300-1 for processing an efficient instruction that pertains to moving data “D” from a physical register 110 (P #) to a stack 112 in the second architecture 300 (FIG. 3). An efficient push instruction, for example, can target the fourth and fifth logical registers L4 and L5. In response to the efficient push instruction, the logic circuitry 106 can mark in the register mapping table 302 that the fourth and fifth physical registers P4 and P5 are associated with a pending move of the data “D” to the stack 112. This is depicted in FIG. 3-1 as a pending data move indication 306 (PDMI 306) that is included in or linked to the fourth and fifth mapping entries 304-4 and 304-5. The pending data move indication 306 can mark the logical register (L #), the physical register (P #), the logical register (L #) and the physical register (P #), the physical register (P #) indirectly via the logical register (L #)—or vice versa, some combination thereof, and so forth.

Alternatively, the logic circuitry 106 can create or edit one or more different mapping entries in a separate register mapping table 302 or in a different portion of a same register mapping table 302 that are designated, at least partially, to indicate a pending data move. Although not explicitly shown in FIG. 3-1, the logic circuitry 106 can employ at least one register mapping table 302 that enables a many-to-one scheme. Such a scheme may be used to track the mapping of a logical register (L #) to a physical register (P #) while also incorporating a mapping of the efficient pushes to the stack.

FIG. 3-2 illustrates example implementations 300-2 for processing an efficient instruction that pertains to moving data “D” back from the stack 112 to the physical register 110 (P #) in the second architecture 300 (FIG. 3). An efficient pop instruction, for example, can target the fourth and fifth logical registers L4 and L5. In response to the efficient pop instruction, the logic circuitry 106 can rescind at least one indication 306 in the register mapping table 302 that the fourth and fifth physical registers P4 and P5 are associated with a pending move of the data “D” to the stack 112. No actual physical movement of the data in the register(s) need be implemented to complete the pair of instructions: an efficient push instruction and a corresponding efficient pop instruction.

This is depicted in FIG. 3-2 as clearing (e.g., deleting, canceling, or overriding) the pending data move indication 306 that is included in or linked to the fourth and fifth mapping entries 304-4 and 304-5. An efficient return instruction can be implemented analogously to the techniques described herein for handling efficient pop instructions.

FIG. 3-3 illustrates example implementations 300-3 for processing an instruction that results in a physical register 110 (P #) being freed for use in the second architecture 300 (FIG. 3). At least one instruction can cause physical registers 110-4 to 110-8 to be allocated to “new” logical registers. In response to the at least one instruction, the logic circuitry 106 can rescind in the register mapping table 302 at least one indication 306 that the fourth and fifth physical registers P4 and P5 are associated with a pending move of the data “D” to the stack 112. To perform the move, the logic circuitry 106 also pushes the data “D” of the previous L4/P4 and the data “D” of the previous L5/P5 onto the stack 112.

This is depicted in FIG. 3-3 as deleting or canceling the pending data move indication 306 that is included in or linked to the previous fourth and fifth mapping entries 304-4 and 304-5. The previous data “D” for the two registers L4/P4 and L5/P5 are also pushed onto the bottom of the stack 112. Further, the five new register allocations are included in the register mapping table 302 at mapping entries 304-4, 304-5, 304-6, 304-7, and 304-8.

Efficient stack-related processor instructions can also be referred to as “lazy” stack-related processor instructions inasmuch as the physical movement of data can be termed “lazy.” The “lazy” aspect arises from deferring the data movement and “trying” to avoid physically moving the data until such movement becomes “necessary” because zero physical registers are available or “prudent” because a quantity of unallocated physical registers drops below a value intended to reduce a likelihood of processor stalls that occur due to performing deferred data moves.

The techniques described herein for efficient stack-related processor instructions can provide a number of advantages. In a sense, the physical registers can be used as a cache for the stack. By removing writes to and reads from the stack when control flow of a program can fit within the physical registers, processor cache space and memory accesses can be better allocated to other data accesses. For example, instruction cache space and additional memory accesses may be freed up for other purposes. Further, avoiding external memory accesses can lower power consumption. There can also be reduced advantages of inlining code, which reduces code size.

Processing performance may be improved by removing control flow dependencies from cache and external memory. If efficiently pushed register values are to be flushed to the stack eventually, there can be a combined relatively larger write to memory instead of multiple smaller write operations. Additionally, because memory on the stack need not be consistent for non-pop operations, out-of-order execution can be partially unblocked. Also, compilers can be adapted to intelligently select between “normal” non-efficient push/pop instruction pairs or efficient push/pop instruction pairs based on context, if both pairs of instructions are included in a given ISA.

There are multiple approaches to handling stack pointer operations in conjunction with implementations for efficient stack-related processor instructions. First, responsive to a change to the stack pointer, the logic circuitry can flush the state of efficiently pushed data values from one or more physical registers to the stack. For example, the data stored in each physical register that is associated with a pending data move to the stack can be moved to the stack based on any stack pointer adjustment.

In a second approach to handling stack pointer operations, the logic circuitry can implement frames on the stack. Responsive to the stack pointer being incremented, the logic circuitry can reserve one or more contiguous stack locations with a pointer to at least one of the stack locations that is representative of the frame. If the data of a deferred push to the stack is to be moved, the data is moved to the stack location(s) in the assigned frame. The architecture may support a finite quantity of frames to support efficient stack-related processor instructions. If the finite quantity is exhausted, the data values for the state corresponding to one or more frames, up to all frames, is flushed to the stack.

For a third approach to handling stack pointer operations in conjunction with implementations for efficient stack-related processor instructions, an architecture can enable multiple stacks per thread in which one of the stacks stores values that are efficiently pushed from physical registers. This stack can save register values for functions and return addresses. Incrementing of the stack pointer can be delayed until data values are flushed to the stack. The stack that stores the efficiently pushed values can be protected relative to other code—e.g., by restricting at least write access using any suitable mechanism, such as at least one virtual memory page-protection bit. This third approach can also include a third stack usable for stack memory allocations that are not performed through an efficient stack-related processor instruction. This third stack can be used, for example, if a program is to allocate memory for an uninitialized variable or a variable that may be read from or written to without using an efficient stack operation that tracks deferred data moves to a stack. The separate stack technique of the third approach can be more efficient than the first approach and simpler than the second approach. Further, the security of code execution can be superior using a memory protection mechanism with the third approach.

Having generally described schemes, techniques, and hardware for implementing efficient stack-related processor instructions, this discussion now turns to example methods.

### Example Methods

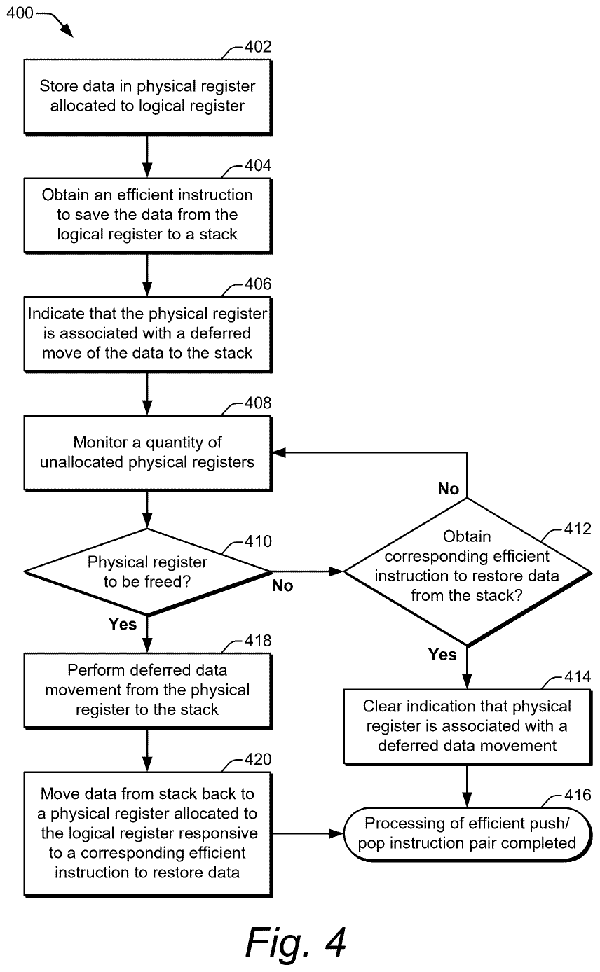

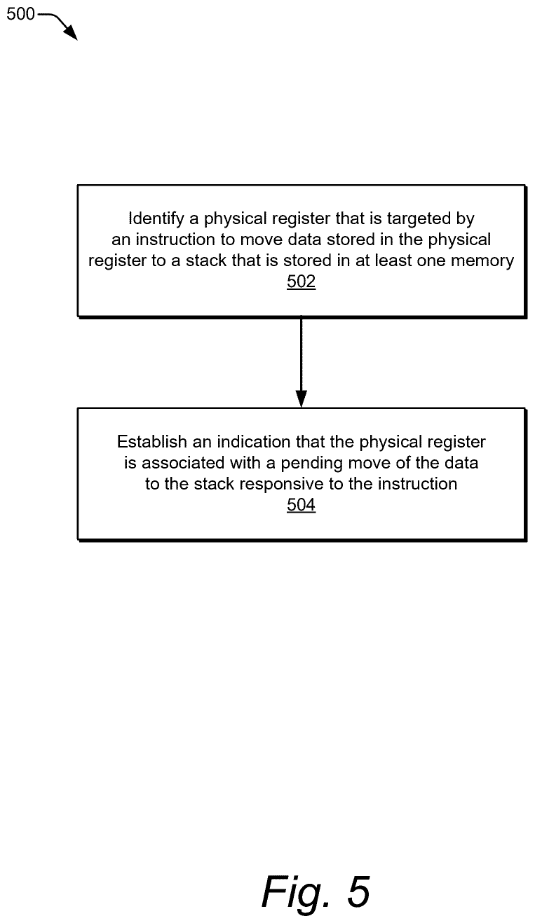

Example methods are described below with reference to the flow chart of FIG. 4 and the flow diagram of FIG. 5. Although example method aspects are described separately below, they may be implemented together in any combination or permutation.

FIG. 4 is a flow chart 400 illustrating an example process for implementing efficient stack-related processor instructions. The flow chart 400 includes ten blocks 402-420. The operations of the example processes can be performed by electronic circuit components as described herein. For example, the operations may be performed by at least one instance of logic circuitry 106 in conjunction with at least one physical register 110, at least one memory 202, and/or at least one register mapping table 302.

At 402, logic circuitry 106 can store data 114 in a physical register 110-3 that is allocated to a logical register 108-2. At 404, the logic circuitry 106 can obtain an efficient instruction 220 to save the data 114 from the logical register 108-2 to the stack 112. At 406, based on a mapping 208 of the logical register 108-2 to the physical register 110-3, the logic circuitry 106 can indicate 224 that the physical register 110-3 is associated with a deferred move of the data 114 to the stack 112—e.g., using at least one indication 222.

At 408, the logic circuitry 106 can monitor a quantity of unallocated physical registers (e.g., of multiple physical registers 110-1 to 110-P). At 410, the logic circuitry 106 determines if the physical register 110-3 is to be freed. For example, another instruction 220 may reference a logical register that is allocated to the physical register 110-3 having the pending data move 242 associated therewith. Alternatively, the logic circuitry 106 may determine one or more physical registers, including the physical register 110-3, are to be freed due to the quantity of unallocated physical registers, which is determined at 408, meeting at least one threshold 210, which threshold may relate to a minimum number of unallocated physical registers. Conversely, the logic circuitry 106 may monitor a quantity of allocated physical registers and perform a comparison with a threshold 210 relating to a maximum number of allocated physical registers.

If no physical registers are to be freed (as determined at 410), the logic circuitry 106 can determine at 412 if a corresponding efficient instruction to restore the data 114 from the stack 112 has been obtained. If not, the logic circuitry 106 can continue monitoring at 408. However, if a corresponding efficient instruction has been received (the “Yes” branch from 412), then at 414 the logic circuitry 106 can clear the indication 222 that the physical register 110-3 is associated with a deferred data movement. An efficient pop instruction for a same logical register 108-2 or physical register 110-3 can correspond to an earlier efficient push instruction. Similarly, an efficient return instruction relating to a same logical register 108-2 or physical register 110-3 can correspond to an earlier efficient call instruction. At 416, the processing of an efficient push/pop instruction pair (or an efficient call/return instruction pair) is completed.

On the other hand, if at 410 the physical register 110-3 is determined to be freed (the “Yes” branch), then at 418 the logic circuitry 106 can perform a deferred data movement 242 from the physical register 110-3 to the stack 112. Further, after some time has elapsed or one or more instructions have been executed, at 420 the logic circuitry 106 can move the data 114 from the stack 112 back to a physical register 110 (which may or may not be the same physical register 110-3) that is allocated for a corresponding efficient instruction to restore the data 114 (e.g., to perform a data move 244 for an efficient pop or return instruction). At 416, the processing of an efficient push/pop instruction pair (or an efficient call/return instruction pair) is completed.

FIG. 5 is a flow diagram 500 illustrating an example process for implementing efficient stack-related processor instructions. The flow diagram 500 includes two blocks 502 and 504. The operations of the example processes can be performed by electronic circuit components as described herein. For example, the operations may be performed by at least one instance of logic circuitry 106 in conjunction with at least one physical register 110, at least one memory 202, and/or at least one register mapping table 302.

At block 502, a physical register that is targeted by an instruction to move data stored in the physical register to a stack that is stored in at least one memory is identified. For example, logic circuitry 106 can identify a physical register 110-3 that is targeted by an instruction 220-1 to move data 114 stored in the physical register 110-3 to a stack 112 that is stored in at least one memory 202. For instance, the logic circuitry 106 can ascertain that an efficient push or call instruction references a logical register 108-2 that is mapped to the physical register 110-3.

At block 504, an indication that the physical register is associated with a pending move of the data to the stack is established responsive to the instruction. For example, the logic circuitry 106 can establish an indication 222 that the physical register 110-3 is associated with a pending move of the data 114 to the stack 112 responsive to the instruction 220-1. In some cases, the logic circuitry 106 can change at least one bit corresponding to the physical register 110-3, with the at least one bit indicative that the data 114 stored in the physical register 110-3 has a deferred write to the stack 112. Additionally or alternatively, the logic circuitry 106 may modify an existing mapping entry 304 of a register mapping table 302 or create a new mapping entry 304 in a same or a different register mapping table 302 to indicate 224 that the physical register 110-3 is associated with a pending data move 242.

Aspects of these methods may be implemented in, for example, hardware (e.g., fixed logic circuitry, a controller, a finite state machine, or a processor in conjunction with a memory), firmware, software, or some combination thereof. The methods may be realized using one or more of the apparatuses or components shown in FIGS. 1 to 3-3 and 6, which components may be further divided, combined, and so on. The devices and components of these figures generally represent hardware, such as electronic devices, PCBs, packaged modules, IC chips, components, or circuits; firmware; software; or a combination thereof. Thus, these figures illustrate some of the many possible systems or apparatuses capable of implementing the described methods.

For the methods described herein and the associated flow chart(s) and flow diagram(s), the orders in which operations are shown and/or described are not intended to be construed as a limitation. Instead, any number or combination of the described method operations can be combined in any order to implement a given method or an alternative method, including by combining operations from the flow chart or diagram and the earlier-described schemes and techniques into one or more methods. Operations may also be omitted from or added to the described methods. Further, described operations can be implemented in fully or partially overlapping manners.

### Additional Example Apparatuses and Electronic Devices

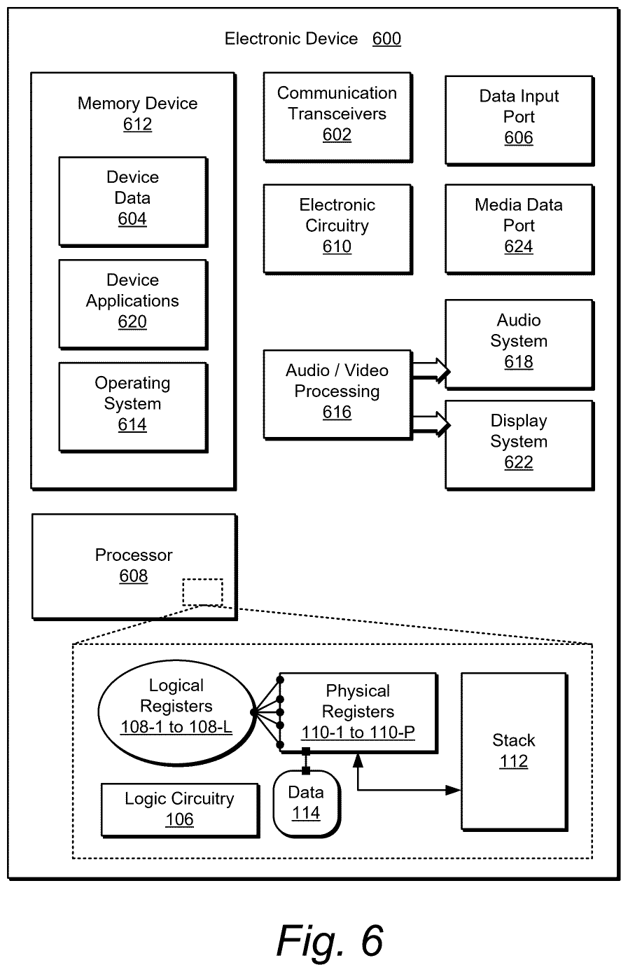

FIG. 6 illustrates various components of an example electronic device 600 that can implement efficient stack-related processor instructions in accordance with one or more described aspects. The electronic device 600 may be implemented as any one or combination of a fixed, mobile, stand-alone, or embedded device; in any form of a consumer, computer, portable, user, server, communication, phone, navigation, gaming, audio, camera, messaging, media playback, and/or other type of electronic device 600, such as the smartphone that is depicted in FIG. 1 as the apparatus 102. One or more of the illustrated components may be realized as discrete components or as integrated components on at least one integrated circuit of the electronic device 600.

The electronic device 600 can include one or more communication transceivers 602 that enable wired and/or wireless communication of device data 604, such as received data, transmitted data, or other information identified above. Example communication transceivers 602 include near-field communication (NFC) transceivers, wireless personal area network (PAN) (WPAN) radios compliant with various IEEE 802.15 (Bluetooth™) standards, wireless local area network (LAN) (WLAN) radios compliant with any of the various IEEE 802.11 (Wi-Fi™) standards, wireless wide area network (WAN) (WWAN) radios (e.g., those that are 3GPP-compliant) for cellular telephony, wireless metropolitan area network (MAN) (WMAN) radios compliant with various IEEE 802.16 (WiMAX™) standards, infrared (IR) transceivers compliant with an Infrared Data Association (IrDA) protocol, and wired local area network (LAN) (WLAN) Ethernet transceivers.

The electronic device 600 may also include one or more data input ports 606 via which any type of data, media content, and/or other inputs can be received, such as user-selectable inputs, messages, applications, music, television content, recorded video content, and any other type of audio, video, and/or image data received from any content and/or data source, including a sensor like a microphone or a camera. The data input ports 606 may include USB ports, coaxial cable ports, fiber optic ports for optical fiber interconnects or cabling, and other serial or parallel connectors (including internal connectors) for flash memory, DVDs, CDs, and the like. These data input ports 606 may be used to couple the electronic device to components, peripherals, or accessories such as keyboards, microphones, cameras, or other sensors.

The electronic device 600 of this example includes at least one processor 608 (e.g., any one or more of application processors, microprocessors, digital-signal processors (DSPs), controllers, and the like), which can include a combined processor and memory system (e.g., implemented as part of an SoC), that processes (e.g., executes) computer-executable instructions to control operation of the device. The processor 608 may be implemented as an application processor, embedded controller, microcontroller, security processor, artificial intelligence (AI) accelerator, and the like. Generally, a processor or processing system may be implemented at least partially in hardware, which can include components of an integrated circuit or on chip system, a digital signal processor (DSP), an application-specific integrated circuit (ASIC), a field programmable gate array (FPGA), a complex programmable logic device (CPLD), and other implementations in silicon and/or other materials.

Alternatively or additionally, the electronic device 600 can be implemented with any one or combination of electronic circuitry, which may include software, hardware, firmware, or fixed logic circuitry that is implemented in connection with processing and control circuits, which are generally indicated at 610 (as electronic circuitry 610). This electronic circuitry 610 can implement executable or hardware-based modules (not shown in FIG. 6), such as through processing/computer-executable instructions stored on computer-readable media, through logic circuitry and/or hardware (e.g., such as an FPGA), and so forth.

Although not shown, the electronic device 600 can include a system bus, interconnect, crossbar, data transfer system, or other switch fabric that couples the various components within the device. A system bus or interconnect can include any one or a combination of different bus structures, such as a memory bus or memory controller, a peripheral bus, a universal serial bus (USB), and/or a processor or local bus that utilizes any of a variety of bus architectures.

The electronic device 600 also includes one or more memory devices 612 that enable data storage, examples of which include random-access memory (RAM), non-volatile memory (e.g., read-only memory (ROM), flash memory, EPROM, and EEPROM), and a disk storage device. Thus, the memory device(s) 612 can be distributed across different logical storage levels of a system as well as at different physical components. The memory device(s) 612 provide data storage mechanisms to store the device data 604, other types of code and/or data, and various device applications 620 (e.g., software applications or programs). For example, an operating system 614 can be maintained as software instructions within the memory device 612 and executed by the processor 608.

In some implementations, the electronic device 600 also includes an audio and/or video processing system 616 that processes audio data and/or passes through the audio and video data to an audio system 618 and/or to a display system 622 (e.g., a video buffer or a screen of a smartphone or camera). The audio system 618 and/or the display system 622 may include any devices that process, display, and/or otherwise render audio, video, display, and/or image data. Display data and audio signals can be communicated to an audio component and/or to a display component via an RF (radio-frequency) link, S-video link, HDMI (high-definition multimedia interface), composite video link, component video link, DVI (digital video interface), analog audio connection, video bus, or other similar communication link, such as a media data port 624. In some implementations, the audio system 618 and/or the display system 622 are external or separate components of the electronic device 600. Alternatively, the display system 622, for example, can be an integrated component of the example electronic device 600, such as part of an integrated touch interface.

The electronic device 600 of FIG. 6 is an example implementation of the apparatus 102 of FIG. 1, an example implementation of a device that can implement the example first and second architectures 200 and 300 respectively of FIGS. 2 and 3, and an example implementation of a device that can implement a method of FIGS. 4 and 5. The electronic device 600 can thus include logic circuitry 106, multiple logical registers 108-1 to 108-L, multiple physical registers 110-1 to 110-P, at least one stack 112, and/or data 114. Accordingly, one or more of the illustrated components may be integrated on the same IC chip, like the processor 608 (which can correspond to the processor 116) and/or an SoC. The stack 112 can be stored at least partially in the memory device 612.

### Example Aspects and Implementations for Efficient Stack-Related Processor Instructions

In the following, some example aspects and implementations are described:

Example aspect 1: An apparatus for implementing efficient stack-related processor instructions, the apparatus comprising: multiple physical registers; at least one memory; and logic circuitry coupled to the multiple physical registers and the at least one memory, the logic circuitry configured to: identify a physical register that is targeted by an instruction to move data stored in the physical register to a stack that is stored in the at least one memory; and establish an indication that the physical register is associated with a pending move of the data to the stack responsive to the instruction.

Example aspect 2: The apparatus of example aspect 1, wherein the logic circuitry is further configured to: rescind the indication that the physical register is associated with a pending move of the data to the stack responsive to another instruction that targets the data of the physical register for a move from the stack.

Example aspect 3: The apparatus of example aspect 1 or example aspect 2, wherein the logic circuitry is further configured to: allocate the physical register to a logical register based on the indication and responsive to another instruction that targets the data of the physical register for a move from the stack to the multiple physical registers.

Example aspect 4: The apparatus of any one of example aspects 1 to 3, wherein the logic circuitry is further configured to: reallocate the physical register to the logical register while the data is continuously stored in the physical register between processing the instruction and processing the other instruction.

Example aspect 5: The apparatus of any one of example aspects 1 to 4, wherein the logic circuitry is further configured to: reactivate in a register mapping table an entry that maps the logical register to the physical register to reallocate the physical register to the logical register responsive to the other instruction.

Example aspect 6: The apparatus of any one of example aspects 1 to 5, wherein the logic circuitry is further configured to: move the data from the physical register to the stack responsive to the indication and to another instruction that is to use at least one physical register of the multiple physical registers.

Example aspect 7: The apparatus of any one of example aspects 1 to 6, wherein the logic circuitry is further configured to: move the data from the physical register to the stack based on a quantity of unallocated physical registers of the multiple physical registers and at least one threshold.

Example aspect 8: The apparatus of any one of example aspects 1 to 7, wherein the at least one physical register comprises the physical register that is storing the data prior to processing the other instruction.

Example aspect 9: The apparatus of any one of example aspects 1 to 8, wherein the logic circuitry is further configured to: write to at least one bit corresponding to the physical register to establish the indication that the physical register is associated with a pending move of the data to the stack.

Example aspect 10: The apparatus of any one of example aspects 1 to 9, wherein the logic circuitry is further configured to: write to at least one table corresponding to the multiple physical registers to establish the indication that the physical register is associated with a pending move of the data to the stack.

Example aspect 11: The apparatus of any one of example aspects 1 to 10, wherein: the at least one table comprises at least part of a register mapping table; and the logic circuitry is further configured to: mark in the register mapping table that the physical register is associated with a pending move of the data to the stack.

Example aspect 12: The apparatus of any one of example aspects 1 to 11, wherein the instruction comprises an efficient stack-related processor instruction pertaining to at least one data move from the multiple physical registers to the stack, the at least one data move being deferrable based on a quantity of available physical registers of the multiple physical registers.

Example aspect 13: The apparatus of any one of example aspects 1 to 12, wherein the efficient stack-related processor instruction comprises at least one of an efficient push instruction or an efficient call instruction.

Example aspect 14: A method for implementing efficient stack-related processor instructions, the method comprising: identifying a physical register that is targeted by an instruction to move data stored in the physical register to a stack that is stored in at least one memory; and establishing an indication that the physical register is associated with a pending move of the data to the stack responsive to the instruction.

Example aspect 15: The method of example aspect 14, further comprising: responsive to another instruction that targets the data stored in the physical register for a move from the stack to the physical register, rescinding the indication that the physical register is associated with a pending move of the data to the stack; or responsive to the indication and a quantity of unallocated physical registers, moving the data from the physical register to the stack.

Example aspect 16: A processor for implementing efficient stack-related processor instructions, the processor comprising: multiple physical registers; and logic circuitry coupled to the multiple physical registers, the logic circuitry configured to defer a data move from a physical register of the multiple physical registers to a stack in response to an instruction to perform the data move and based at least partially on a quantity of unallocated physical registers of the multiple physical registers.

Example aspect 17: The processor of example aspect 16, wherein the logic circuitry is configured to: cancel the data move from the physical register to the stack in response to another instruction to perform a data move from the stack to the physical register.

Example aspect 18: The processor of example aspect 16 or example aspect 17, wherein the logic circuitry is configured to maintain same data in the physical register between processing the instruction and processing the other instruction.

Example aspect 19: The processor of any one of example aspects 16 to 18, wherein: the instruction comprises at least one of an efficient push instruction or an efficient call instruction; and the processor is configured to implement at least one of a push instruction or a call instruction in which data moves from the multiple physical registers to the stack are performed without deferring the data moves based on the quantity of unallocated physical registers of the multiple physical registers.

Example aspect 20: The processor of any one of example aspects 16 to 19, wherein the logic circuitry is configured to: perform the data move from the physical register to the stack based on the quantity of unallocated physical registers of the multiple physical registers meeting at least one threshold.

Example aspect 21: An apparatus comprising: a processor configured to perform the method of example aspect 14 or example aspect 15.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Although implementations for realizing efficient stack-related processor instructions have been described in language specific to certain features and/or methods, the subject of the appended claims is not necessarily limited to the specific features or methods described. Rather, the specific features and methods are disclosed as example implementations for realizing efficient stack-related processor instructions.

1. An apparatus for implementing efficient stack-related processor instructions, the apparatus comprising:
multiple physical registers;
at least one memory; and
logic circuitry coupled to the multiple physical registers and the at least one memory, the logic circuitry configured to:
identify a physical register that is targeted by an instruction to move data stored in the physical register to a stack that is stored in the at least one memory; and
establish an indication that the physical register is associated with a pending move of the data to the stack responsive to the instruction.

2. The apparatus of claim 1, wherein the logic circuitry is further configured to:
rescind the indication that the physical register is associated with a pending move of the data to the stack responsive to another instruction that targets the data of the physical register for a move from the stack.

3. The apparatus of claim 1, wherein the logic circuitry is further configured to:
allocate the physical register to a logical register based on the indication and responsive to another instruction that targets the data of the physical register for a move from the stack to the multiple physical registers.

4. The apparatus of claim 3, wherein the logic circuitry is further configured to:
reallocate the physical register to the logical register while the data is continuously stored in the physical register between processing the instruction and processing the other instruction.

5. The apparatus of claim 4, wherein the logic circuitry is further configured to:
reactivate in a register mapping table an entry that maps the logical register to the physical register to reallocate the physical register to the logical register responsive to the other instruction.

6. The apparatus of claim 1, wherein the logic circuitry is further configured to:
move the data from the physical register to the stack responsive to the indication and to another instruction that is to use at least one physical register of the multiple physical registers.

7. The apparatus of claim 6, wherein the logic circuitry is further configured to:
move the data from the physical register to the stack based on a quantity of unallocated physical registers of the multiple physical registers and at least one threshold.

8. The apparatus of claim 6, wherein the at least one physical register comprises the physical register that is storing the data prior to processing the other instruction.

9. The apparatus of claim 1, wherein the logic circuitry is further configured to:
write to at least one bit corresponding to the physical register to establish the indication that the physical register is associated with a pending move of the data to the stack.

10. The apparatus of claim 1, wherein the logic circuitry is further configured to:
write to at least one table corresponding to the multiple physical registers to establish the indication that the physical register is associated with a pending move of the data to the stack.

11. The apparatus of claim 10, wherein:
the at least one table comprises at least part of a register mapping table; and
the logic circuitry is further configured to:
mark in the register mapping table that the physical register is associated with a pending move of the data to the stack.

12. The apparatus of claim 1, wherein the instruction comprises an efficient stack-related processor instruction pertaining to at least one data move from the multiple physical registers to the stack, the at least one data move being deferrable based on a quantity of available physical registers of the multiple physical registers.

13. The apparatus of claim 12, wherein the efficient stack-related processor instruction comprises at least one of an efficient push instruction or an efficient call instruction.

14. A method for implementing efficient stack-related processor instructions, the method comprising:
identifying a physical register that is targeted by an instruction to move data stored in the physical register to a stack that is stored in at least one memory; and
establishing an indication that the physical register is associated with a pending move of the data to the stack responsive to the instruction.

15. The method of claim 14, further comprising:
responsive to another instruction that targets the data stored in the physical register for a move from the stack to the physical register, rescinding the indication that the physical register is associated with a pending move of the data to the stack; or
responsive to the indication and a quantity of unallocated physical registers, moving the data from the physical register to the stack.

16. A processor for implementing efficient stack-related processor instructions, the processor comprising:
multiple physical registers; and
logic circuitry coupled to the multiple physical registers, the logic circuitry configured to defer a data move from a physical register of the multiple physical registers to a stack in response to an instruction to perform the data move and based at least partially on a quantity of unallocated physical registers of the multiple physical registers.

17. The processor of claim 16, wherein the logic circuitry is configured to:
cancel the data move from the physical register to the stack in response to another instruction to perform a data move from the stack to the physical register.

18. The processor of claim 17, wherein the logic circuitry is configured to maintain same data in the physical register between processing the instruction and processing the other instruction.

19. The processor of claim 18, wherein:
the instruction comprises at least one of an efficient push instruction or an efficient call instruction; and
the processor is configured to implement at least one of a push instruction or a call instruction in which data moves from the multiple physical registers to the stack are performed without deferring the data moves based on the quantity of unallocated physical registers of the multiple physical registers.

20. The processor of claim 16, wherein the logic circuitry is configured to:
perform the data move from the physical register to the stack based on the quantity of unallocated physical registers of the multiple physical registers meeting at least one threshold.
